(19) United States
(12) Patent Application Publication
(10) Pub. No.: US 2026/0070725 A1
(43) Pub. Date: Mar. 12, 2026

(54) Blister sealing film and blister package and method for their production

(71) Applicant: Constantia Teich GmbH, Weinburg (AT)

(72) Inventors: Helwig DAUM, Willingshausen (DE); Paolo BATTISTON, Sankt Pölten (AT); Wilhelm ZUSER, Herzogenburg (AT)

(21) Appl. No.: 19/108,386

(22) PCT Filed: Aug. 21, 2023
(86) PCT No.: PCT/EP2023/072915

§ 371 Date: Mar. 3, 2025

(30) Foreign Application Priority Data
Sep. 2, 2022 (DE) 10 2022 122 331.0

(51) Int. Cl. B65D 75/36; B32B 5/02; B32B 27/12; B65D 65/40

(52) U.S. Cl. CPC B65D 75/367; B32B 5/022; B32B 27/12; B65D 65/40; B32B 2250/03; B32B 2250/04; B32B 2307/5825; B32B 2439/00

(57) ABSTRACT

Disclosed is a blister sealing film having a first plastic which is connected to a nonwoven whose fibres contain a second plastic which is predominantly based on the same polymers/copolymers as the first plastic. Also disclosed is a blister package having a blister bottom film and such a blister sealing film. Also disclosed is a method for producing a blister sealing film by providing a nonwoven fabric which has a second plastic, providing a first plastic which is predominantly based on the same polymers/copolymers as the second plastic, and bonding the nonwoven fabric to this first plastic

### BACKGROUND OF THE INVENTION

The invention relates to a blister sealing film comprising a first plastic. The invention also relates to a blister package comprising a blister bottom film and such a blister sealing film. The invention also relates to a method for producing a blister sealing film.

Sensitive products that are packaged individually or in small quantities are often supplied in transparent package, also known as blister packages. As can be seen from the English meaning of the term “blister”, a first part of such package forms a cavity that can hold the goods to be packaged. A second part of the package covers the opening of the cavity so that the goods contained in the blister are completely enclosed. The second part of the package often has information on the product contained.

The first part of the package is often transparent so that the customer can see and visually assess the product inside. Such embodiments are frequently used, for example, for electrical items such as lamps, chargers, cables, memory cards and memory sticks, hygiene products such as toothbrushes, office supplies such as pens, printer cartridges, adhesive tapes and adhesives, foodstuffs such as meat, fish and desserts, laboratory equipment and medical and pharmaceutical products such as ampoules, tablets, syringes, cannulas and bandages. In these cases, the second part of the package is often paper or plastic. In order to dispose of the package material according to type, it is often sufficient to completely remove the second part of the package from the first part of the package and dispose of the two parts separately. If both parts of the packages are made of the same material, for example the same type of plastic, they can be disposed of together.

For some sensitive, particularly light-sensitive, products such as medicines, hygiene products and laboratory materials, it is preferable to use an opaque first part of the package. For such sensitive products, diffusion of air, such as can occur through some plastics and paper, should also be avoided. Therefore, the second part of the package often comprises an aluminium foil that is sealed against the first part of the package.

In the manufacture of such packages and the packaging of the products, thermoforming films (made of PVC, for example) are usually used (also known as blister base film), in the cavity(ies) of which the product(s) are placed. All cavities are then sealed over their entire surface with (for example partially printed) aluminium foil. This is done, for example, by plate or roller sealing. The first part of the package(the blister) is joined to the second part of the package (the blister sealing foil or blister lidding foil). Typically, blister cards with a predetermined number of products are then punched out of the blister bottom film sealed with the blister sealing film and secondary packaged.

With this type of blister package, the end user usually gains access to the product by pushing the product (e.g. a tablet) through the blister lidding film. The blister lidding film tears open locally so that the product can be pushed out of the package through the tear and becomes accessible. In the past, blister lidding films made of (preferably hard) aluminium have proven to be particularly suitable, as on the one hand they allow the product to be pushed through easily and on the other hand the aluminium film is particularly easy to handle due to its good thermal conductivity and temperature resistance when heat is applied during a sealing process and allows high packaging outputs.

However, one problem with this type of blister packages is its recycling. The materials used are usually sealed flat against each other and are not, or at least not completely, separated from each other when the product is removed. Instead, the (metal-containing) blister sealing film usually remains completely bonded to the plastic of the blister bottom film and the product is only removed through a tear in the blister sealing film. Accordingly, the plastic of the blister bottom film and the (usually metal-containing) blister sealimg film are disposed of together. As the materials of the blister packages are present as a mixture, recycling by type is not possible or only possible with increased effort. For this reason, the blister packages known from the state of the art are not recycled in most cases.

In the past, attempts have already been made to provide blister sealing film based on the same plastic as the blister bottom film. In order to enable the blister sealing film to be torn open when subjected to pressure by the end customer, it was proposed to provide the blister sealing film with predetermined breaking points. For this purpose, the blister sealing film was scored on one side. However, this is extremely difficult, especially with large-format films, as the depth of the scoring must be precisely controlled across the entire working width in order to ensure a specified tear resistance of the packaging film on the one hand and sufficient local weakening of the puncture resistance on the other.

Other attempts have been made to mechanically weaken the plastic of the blister sealing film using mineral additives. However, such packages also have the disadvantage that the plastic contains foreign substances due to the mineral additives and is therefore difficult to recycle. The additives can also pose a health risk and/or react with the ingredients of the product to be protected by the blister packages. This is particularly risky and undesirable for high-quality and sensitive products such as pharmaceuticals. Furthermore, the puncture resistance of such films cannot be precisely controlled, at least in some cases, nor does it have the desired load profile for blister packages, where the force required to deform the film increases steadily until it tears.

Accordingly, the present invention is based on the task of providing a blister sealing film which can be recycled together with the blister bottom film, preferably under normal recycling conditions, and which can also be opened in a similar way to a metal-containing blister sealing film.

### SUMMARY OF THE INVENTION

An essential point of the invention is that a blister sealing film according to the invention comprises a first plastic, wherein this first plastic is connected to a nonwoven whose fibres contain a second plastic which is predominantly based on the same polymers/copolymers as the first plastic. Surprisingly, it has been shown that a combination of a nonwoven fabric and a plastic has properties that are similar to those of known metal-containing blister sealing films. Just like metal-containing blister sealing films, at least preferred embodiments of a blister sealing film according to the invention are printable.

In a preferred embodiment, the first plastic is composed of two or more layers and/or coatings. Preferably, one of these layers is a film and in particular a coextruded film. Preferably, this film consists of EVOH.

Preferably, furthermore, a metallisation is provided and preferably this metallisation is arranged on this above-mentioned film.

The plastic preferably has a further layer and in particular a tie layer. This further layer is arranged in particular on the metallisation or on the film.

A further layer is preferably provided, which consists in particular of HDPE. This further layer is preferably arranged on the tie layer.

In a preferred embodiment, the blister sealing film can be pushed through and, in particular, can be pushed through by a user. In a further preferred embodiment, the blister sealing film is not peelable and/or not removable (in particular from other components of a package).

Preferably, the blister sealing film is not peelable or removable in one piece.

Preferably, at least 70 per cent by weight of the first plastic and the second plastic, preferably ≥80 per cent by weight, more preferably ≥90 per cent by weight, particularly preferably ≥95 per cent by weight are based on the same polymers/copolymers. Due to the high proportion of plastics based on identical polymers/copolymers, recycling is particularly efficient and simple. In the context of the present invention, plastics are to be understood as being based on the same polymers/copolymers if their polymer chains comprise at least the proportion of repetitive units specified above. It is not necessary that these repetitive units are actually produced from identical monomers. Rather, plastics whose repetitive units were obtained, for example, by linking oligomers are also included. Due to the high proportion of identical repetitive units in the polymers of the plastics, (unmixed) reprocessing is particularly easy during recycling.

Preferably, the blister sealing film comprises a first plastic and a second plastic which are selected from a group comprising polyethylene (PE), polypropylene (PP), polystyrene (PS), polyester, preferably including polylactide (PLA), polyethylene terephthalate (PET) or polycarbonate (PC), ethylene-vinyl alcohol copolymer (EVOH) and mixtures thereof. These plastics are particularly favoured, as established and cost-effective recycling processes are known for them. Accordingly, plants already exist in which these plastics can be sorted out and processed from a mixture of plastic waste. In particular, with the above-mentioned high proportion of identical repetitive units in the polymers of the two plastics (namely the first and second plastics), it is possible to process these polymers by type and reuse them.

Preferably, the thickness of the first plastic and/or the nonwoven of the blister sealing film is selected such that a puncture resistance of the blister sealing film measured in accordance with DIN EN ISO 14477 with a mandrel of 10.5 mm diameter essentially corresponds to a puncture resistance of a 20 μm thick aluminium foil. In this context, it should be understood as essentially corresponding to a puncture resistance of a 20 μm thick aluminium foil that the puncture resistance of the blister sealing foil measured in accordance with DIN EN ISO 14477 with a mandrel with a diameter of 10.5 mm≤deviates by 30%, preferably ≤20%, from a puncture resistance of a 20 μm thick aluminium foil. As a result, for a user, opening a blister package with a blister sealing foil as described above can be particularly similar to opening a blister package with a metal-containing blister sealing foil, for example an aluminium foil. It is not necessary for the user to switch to a different type of opening or to use tools. This is particularly advantageous if the blister sealing foil closes a blister package for medication, as this often has to be opened by patients who are not in full possession of their physical strength

Preferably, the thickness of the first plastic material and/or the nonwoven of the blister sealing film is selected such that the puncture resistance of the blister sealing film, measured in accordance with DIN EN ISO 14477 with a mandrel with a diameter of 10.5 mm, is in the range of 15-50 N, preferably 20-35 N, particularly preferably in the range of 25-30 N. In this embodiment of the blister sealing film, it can be ensured on the one hand that a product packaged in a blister package with a blister sealing film as described above is securely protected, but on the other hand that opening by breaking open the blister sealing film is sufficiently easy for a user and can preferably be carried out without tools (or with the aid of the packaged product as a tool for opening the blister sealing film, for example by pushing it through).

If it is desired to make the blister sealing film particularly crush-resistant, for example to provide child-resistant blister package, it is preferable to provide the blister sealing film with an additional plastic layer. Alternatively or additionally, the thickness of the layer of the first plastic and/or the nonwoven can be increased in order to achieve or support this effect.

The use of mineral fillers in a polymer-based blister sealing films, as known from the prior art, has proven to be particularly disadvantageous in terms of its behaviour when subjected to pressure. Due to the mineral additives, it often happens that the force required to deform the blister sealing film until it tears open does not increase continuously when pressure is applied by a user, but instead reaches a maximum. This means that the maximum force required to deform the blister sealing film does not have to be applied during the deformation required to tear it open. This property is described in detail in connection with FIG. 4. This property of the polymer-based blister sealing film containing mineral fillers is particularly disadvantageous, as a user does not recognise when the point of maximum force/pressurisation required for deformation has been exceeded or cannot reduce the force/pressurisation in good time before the blister sealing film is opened. As a result, the blister sealing film suddenly tears open and the contents are often ejected from the blister package due to the excessive pressurisation. This is particularly disadvantageous for sensitive and/or high-priced products such as medicines and often means that the product cannot be used.

Therefore, a preferred variant of the blister sealing film is characterised in particular by the fact that a force acting on the blister sealing film, preferably when testing the puncture resistance of the blister sealing film in accordance with DIN EN ISO 14477 with a mandrel with a diameter of 10.5 mm, increases monotonically, preferably strictly monotonically, until the force required for a puncture is reached. It is not absolutely necessary, and in the case of some polymers it cannot be realised with reasonable effort, that the force required to achieve a puncture is linear and/or strictly monotonically increasing. The terms “monotonically increasing” and “strictly monotonically increasing” should therefore be understood in their mathematical meaning. Accordingly, in the case of a strictly monotonic increase, the force/pressurisation required to deform the blister sealing film must increase with increasing deformation. Areas in which increasing deformation of the blister sealing film is possible without a further increase in the force/pressurisation required for this are excluded in this variant. In the case of a monotonic increase, on the other hand, the only requirement is that the force/pressurisation required for deformation in the area under consideration never decreases with increasing deformation of the blister sealing film until the blister sealing film tears. However, areas in which increasing deformation of the blister sealing film is possible without a further increase in the force/pressurisation required for this are possible with this variant.

In a preferred embodiment, the blister sealing film has a sealable layer which preferably has a seal strength of >6 N/15 mm, preferably >9 N/15 mm, particularly preferably >12 N/15 mm, at a sealing temperature in the range of 100-170° C., preferably 110-160° C., more preferably 120-150° C., particularly preferably 130-140° C. with respect to the first plastic comprising a test specimen. This embodiment enables the blister sealing film to be sealed sufficiently firmly and securely against the blister bottom film under normal sealing conditions. Even when the blister package is opened, if the seal strength is in the range described above, the blister sealing film tears in the area where pressure is applied without separating from the blister bottom film in the sealed areas.

Preferably, the sealable layer is a layer that comprises the first plastic. A special sealing layer or a sealing lacquer, as is usually necessary with the blister sealing films known from the prior art when using different materials, is therefore not necessary. Preferably, a blister sealing film therefore has no additional sealing layer on the surface of the first plastic facing away from the nonwoven material. This means that the blister sealing film can contain even fewer foreign materials and can be particularly light. Preferably, such a blister sealing film has a basis weight that is at least 20 %, preferably at least 30 %, more preferably at least 40 % lower than the basis weight of blister sealing films with mineral fillers known from the prior art. The blister sealing film preferably has a basis weight which is in the range of 15-200 g/m², preferably 18-60 g/m² and ideally 20-40 g/m².

A sealing layer is preferably arranged on and/or at the nonwoven. It is possible that a nonwoven, such as a nonwoven made of PE, is sealed directly against the PE-based base.

In another embodiment, a coating is applied to the nonwoven, for example of PE copolymers. This design makes it possible to achieve lower sealing temperatures.

Preferably, the first plastic is designed as a film, preferably as one mouldable film or several mouldable films. A mouldable film is usually characterised by its high puncture resistance.

When combined with a non-woven material, however, the puncture resistance is significantly reduced so that the resulting blister sealing film is easy for a user to open.

The material of the nonwoven is preferably of the same type or at least sufficiently similar to the first plastic. The sameness or similarity ensures that the composite softens at a predetermined temperature and thus becomes sealable.

A blister sealing film in which the nonwoven is bonded to a layer of the first plastic on at least one side, preferably exactly on one side, alternatively on both sides, preferably using the hot bonding process, has proven to be particularly advantageous. In this embodiment, the nonwoven thus forms a layer which is bonded to a layer of the first plastic on at least one of its large side surfaces. The first plastic and/or an adhesive agent can also penetrate or be arranged in intermediate spaces that are formed between the fibres of the nonwoven. The penetration of the first plastic and/or the adhesive is even preferred in some cases in order to achieve improved adhesion between the nonwoven and the first plastic.

Preferably, the nonwoven is bonded to a layer of the first plastic on both sides, as the blister sealing film in this embodiment has a (at least macroscopically) flat surface on both sides, which can be printed on, for example. A flat surface is also preferred on the side facing the filling material in order to avoid mechanical (or chemical) interaction of the non-woven fibres with the filling material.

In a preferred embodiment, the composite is a composite of a nonwoven and a plastic web, with the nonwoven preferably being directly sealed.

It is also conceivable to have designs that are composed of plastic/fleece/plastic, whereby in this case the inner plastic is preferably sealed directly. This plastic (in particular the inner plastic) could also be provided with a seal coating.

In a preferred embodiment of the blister sealing film, the nonwoven comprises stretched fibres and/or the first plastic is uni-or bidirectionally stretched. In particular, the use of stretched fibres in the nonwoven has proven to be advantageous, as further stretching of the fibres is only possible to a limited extent and therefore the force to be applied to tear the blister sealing film can be adjusted comparatively easily. Preferably, the individual fibres are pre-stretched almost to the maximum. As a result, the further stretchability of the nonwoven is very limited. Preferably, the fibres tear when force is applied after an additional elongation or stretching of between 20-300%, preferably between 50 and 200% and particularly preferably between 70-120%.

Furthermore, the use of stretched fibres in the nonwoven can have the advantage that a force acting on the blister sealing film essentially leads to a deformation of the first plastic and the fibres of the nonwoven change almost exclusively in their relative arrangement to each other, but essentially in their length. Accordingly, the force required to tear the blister sealing film can essentially be determined by the force required to tear the (stretched) fibres of the nonwoven. If the fibres tear, the tear continues and the first plastic also tears.

Preferably, the nonwoven has a grammage in the range of 7-100 g/m², preferably 8-50 g/m², particularly preferably 10-20 g/m².

Preferably, the choice of the first plastic and/or the thickness and/or grammage of the first plastic can influence a gradient of the force required to deform the blister sealing film (in a force/deformation diagram). A greater thickness and/or grammage of the first plastic with identical properties of the nonwoven preferably leads to a greater gradient of the force required to deform the blister sealing film in a diagram as described above (see also FIG. 5)

A further essential aspect of the present invention is a blister package comprising a blister bottom film and a blister sealing film as described above. Such a blister package can preferably be recycled using conventional equipment and is easy to open for end users. At the same time, the filling enclosed by the blister packaging is securely protected (until it is opened by the end user).

In a preferred embodiment of such a blister package, the blister botto, film and the blister sealing e film each based at least 80 per cent by weight of a plastic, with at least 70 per cent by weight of these plastics being based on the same polymers/copolymers. This further simplifies recycling, as residues from the blister sealing film that remain attached to the blister bottom film after opening can also be recycled together with the blister botto, film. In order to simplify recycling even further and reduce contamination, it is preferred that the blister bottom film and the blister sealing film each consist of 90 per cent by weight, further preferred ≥95 per cent by weight, in particular preferred ≥98 per cent by weight, of a plastic, whereby these plastics are preferably at least ≥80 per cent by weight, further preferred ≥90 per cent by weight, in particular preferred ≥95 per cent by weight, on the same polymers/copolymers.

Mineral fillers known from the prior art are preferably not present in this embodiment or at least reduced to a level at which they can be regarded as an impurity. Their content is preferably significantly less than 10 per cent by weight, such as ≤5 per cent by weight, preferablys 3 per cent by weight, particularly preferably ≤1 per cent by weight. The problems that occur when recycling plastics with mineral fillers can thus be avoided.

Preferably, a blister package as described above is a blister package for electrical items such as electrical items from a group comprising lamps, chargers, cables, batteries, rechargeable batteries, headphones, microphones, memory cards and memory sticks, for hygiene products such as hygiene products from a group that includes toothbrushes, attachments for electric toothbrushes, dental floss, earplugs, tweezers, mascara, make-up, eyeliner, lipsticks, brushes, nail scissors, cuticle scissors, fragrance dispensers, dummies, razors, cleaning and descaling tablets, for office supplies, such as office supplies from a group comprising pens, pencil sharpeners, printer cartridges, adhesive tapes, glue, erasers, staples and paint rollers, for foodstuffs, such as foodstuffs from a group comprising chewing gum, meat, meat products and foodstuffs from a group which includes chewing gum, meat, fish, ready meals, confectionery and chocolates, for laboratory equipment such as laboratory equipment from a group which includes ampoules, tablets, syringes, cannulas, bandages, pipettes, pipette tips, spatulas, thermometers, spoon spatulas, stoppers, (screw or crimp) caps, sample containers and cuvettes, for medical and/or pharmaceutical products such as medical and/or pharmaceutical products from a group comprising tablets, syringes, cannulae, (fever) thermometers, ampoules, aerosol dispensers and dressings, aerosol dispensers and bandages, for pet supplies products such as pet supplies products from a group comprising pet food, bones, pet toys, tick tweezers and cards, for craft supplies products such as craft supplies products from a group comprising tools, pliers, screwdrivers, screwdrivers, tweezers and cards, pliers, screwdrivers, screws, nuts, nails, cable ties, drills, bits, saw blades, cutting discs, abrasives, planes, magnets, dowels, hooks, eyelets, washers, springs, hose clamps, brackets, hinges, felt gliders, (sewing) needles, as well as products for fishing and angling and/or for toys, such as toys from a group comprising vehicle models, trading cards, (water) pistols, ammunition for toy pistols, (dart) darts, figures, play money, key rings, balls, marbles, beads and handicraft supplies. Such blister package has proven to be particularly advantageous for the above-mentioned goods and groups of goods, as these are offered in large quantities in previously known blister packages, and thus the recycling of a large quantity of packaging can be simplified and/or these goods can be stored, kept and offered in a blister package as described above in a particularly safe and yet easily accessible manner.

The type of plastic is preferably adapted to the product that is to be packaged in the blister package. For example, if products that are sensitive to radiation of a certain wavelength are to be accommodated in a blister pack, it is preferable for the blister pack and/or the blister sealing film to be made of a plastic that has a low permeability to radiation of this wavelength. If necessary, the plastic can contain one or more additives to (further) reduce the transmittance for radiation of this wavelength. Such a design is particularly favored for light-sensitive products such as medicines, hygiene products and/or laboratory materials.

In addition or alternatively, a blister sealing film has at least one barrier property against a substance and/or radiation that is harmful to the filling material. In particular, it is preferred that the blister sealing film has a barrier property against a substance or radiation selected from a group comprising water, a gas, light, MOSH, MOAH, phthalates and other migration substances. Preferably, the barrier property reduces the amount of substance or radiation passing through the blister sealing film by at least 90%, preferably at least 95%, more preferably at least 98%, more preferably at least 99%, and most preferably at least 99.9%. This barrier property of the blister sealing film can be achieved by a polymer contained in the first and/or second plastic. If, despite the selection of a suitable polymer, the barrier property of the blister sealing film is not sufficient, one or more additives can be added to the plastic in order to set the desired barrier property. For example, pigments could be added that absorb radiation of a wavelength that is harmful to the product to be protected.

In addition or as an alternative, it is also conceivable to adjust the desired barrier properties of the blister sealing film by means of an organic and/or inorganic coating. This variant has the advantage that the barrier property can be adjusted by a very thin coating and, according to the current state of the art, this does not have a negative effect on the recycling properties. In a preferred embodiment, the organic and/or inorganic coating is applied to the second plastic The present invention further relates to a method for producing a blister sealing film, in particular a blister sealing film as described above. The method according to the invention is characterized by the
Providing a nonwoven which comprises a second plastic,
Providing a first plastic which is predominantly based on the same polymers/copolymers as the second plastic, and
Bonding the nonwoven to this first plastic.

This method makes it particularly easy to produce a blister sealing film which is similar in its property profile and applicability to the blister sealing films known from the prior art, in particular metal-containing blister sealing films, but which can be recycled much more easily and cost-effectively with currently available systems. This can be justified in particular by the fact that particularly similar plastics based on the same polymers/copolymers are used for the nonwoven with the second plastic and the first plastic, which can be recycled together.

Preferably, the nonwoven is bonded to a layer of the first plastic on at least one side, preferably exactly on one side, alternatively on both sides. This allows a firm bond to be created between the nonwoven and the plastic. Preferably, such a connection is thermally stable, so that at least during a heat-sealing process the connection between the nonwoven and the first plastic is not loosened or the first plastic does not detach from the nonwoven. A layer of the first plastic attached to the nonwoven also offers the advantage that such a layer does not have the fibre structure of the nonwoven on one visible side and is therefore particularly suitable for post-treatment. Such post-treatment can, for example, involve printing and/or embossing. Both printing and embossing are more visible on a visible side that is less structured than the nonwoven.

For example, a print or embossing may include product information such as product name, manufacturer name, manufacturing date, product number, production date, production location, production shift, quality control number, security features, expiry date and/or combinations thereof.

Irrespective of whether printing is present or not, a preferred embodiment of a blister sealing film is also provided, which comprises at least one further layer. This layer is, for example, a lacquer layer. Such a lacquer layer can, for example, serve as a protective lacquer. For example, a lacquer layer could protect a print and/or a security feature. However, it is also conceivable that the lacquer serves to refine the blister sealing film. This finish can, for example, be visually and/or haptically perceptible.

In addition or as an alternative embodiment described above in which the nonwoven is bonded to a layer of the first plastic on at least one side, preferably exactly one side, alternatively on both sides, it is also conceivable and preferred in some process variants that the nonwoven is bonded to a layer of the first plastic on at least one side, preferably exactly one side, alternatively on both sides using the hot bonding process. As with lamination, the hot bonding process can also be used to create a firm bond between the nonwoven and the plastic. Preferably, such a bond is also thermally stable, so that at least during a heat-sealing process the bond between the nonwoven and the first plastic is not loosened or the first plastic does not detach from the nonwoven. A layer of the first plastic applied to the nonwoven using the hot bonding process also offers the advantage that such a layer does not have the fibre structure of the nonwoven on a visible side and is therefore particularly suitable for post-treatment. Such post-treatment can, for example, involve printing and/or embossing. Both printing and embossing are more visible on a visible side that is less structured than the nonwoven.

A further embodiment of the method is also conceivable in which a layer of the first plastic is laminated to one side of the nonwoven and a layer of the first plastic is bonded to the other side of the nonwoven using the hot bonding process. This allows particular flexibility with regard to the properties of the applied layers.

In a further embodiment of the method, the nonwoven or the first plastic is provided with a sealable layer.

Preferably, the blister sealing film is applied to a blister bottom film and preferably bonded to it. In particular, it is preferred that the blister sealing film is sealed onto the blister bottom film. Preferably, the blister package is closed in the process. A product previously into a recess in the blister bottom film is thus enclosed by the blister package. This is a particularly simple way to produce a sealed blister package and securely protect the contents.

### BRIEF DESCRIPTION OF THE DRAWINGS

Further advantages and embodiments are shown in the attached drawings:

Show in it:

FIG. 1 a schematic representation of a blister package according to the invention with blister sealing film;

FIG. 2 a further embodiment of a blister package with blister sealing film according to the invention;

FIG. 3 a schematic representation of the results of a measurement of the puncture resistance of a blister sealing film known from the state of the art, measured in accordance with DIN EN ISO 14477 with a mandrel with a diameter of 10.5 mm;

FIG. 4 a schematic representation of the results of a measurement of the puncture resistance of another blister sealing film known from the state of the art, measured in accordance with DIN EN ISO 14477 with a mandrel with a diameter of 10.5 mm;

FIG. 5 a comparative illustration of the results of a measurement of the puncture resistance of a known metal-containing blister sealing film (A) and a blister sealing film according to the invention (B) measured in accordance with DIN EN ISO 14477 with a mandrel with a diameter of 10.5 mm.

### DETAILED DESCRIPTION OF THE INVENTION

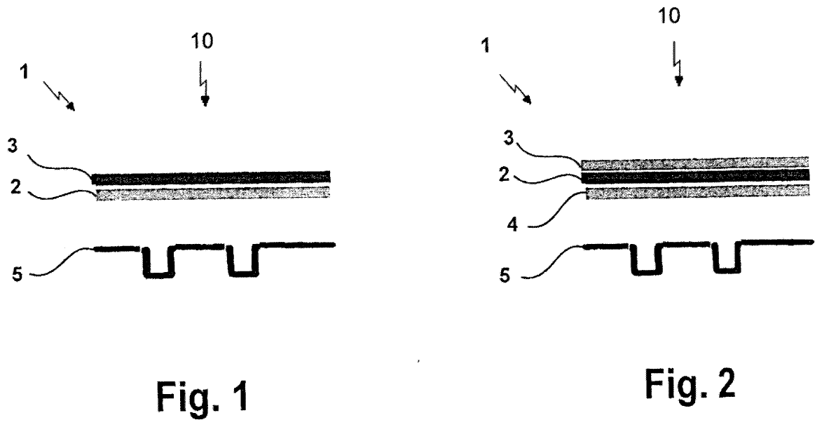

FIG. 1 shows a schematic representation of a blister package 10 according to the invention with blister sealing film 1. The blister package 10 has a blister bottom film 5 which, in the example shown, has a plurality of recesses for holding a filling product to be packaged which is not shown. The openings of these recesses can be closed by a blister sealing film 1.

In the example shown, the blister sealing film 1 consists of a composite comprising a nonwoven 2 and a cover layer 3. The nonwoven 2 is arranged on the side of the blister sealing film 1 facing the product. The cover layer 3 is accordingly arranged on the side of the blister sealing film 1 facing away from the contents. This means that the visible side of the blister package 10 is not formed by the nonwoven 2 and therefore does not have the structure defined by the fibres of the nonwoven 2. Instead, the visible side of the blister sealing film 1 is preferably formed by the plastic layer 3 or cover layer 3. It preferably has no macroscopically perceptible structure or at least a much smaller structure than the nonwoven 2, which means that this side has a pleasant feel for the user and is preferably printable. The cover layer 3 can be arranged either directly or indirectly on the nonwoven 2. In the case of a direct arrangement, the cover layer 3 comprises at least one further (plastic) layer. As mentioned, the cover layer 3 itself can also have several layers and/or consist of several layers.

The blister sealing film 1 and the blister bottom film 5 preferably comprise plastics that are composed of identical polymers/copolymers and/or in which the polymers/copolymers are linked to each other via identical chemical bonds. For example, it is conceivable in this respect that both blister saeling film 1 and blister bottom film 5 are based on polyethylene. However, the plastics may differ in some (chemical and/or physical) properties. For example, the (average) chain length of the polymers of the blister sealing film 1 and the blister bottom film 5 can be different. Similarly, individual layers 2, 3, 4 of the blister sealing film 1 may also differ in their chemical and/or physical properties. Embodiments are also conceivable in which the polymers/copolymers are at least partially different, but the bonds between the polymers/copolymers in the blister sealing e film 1 (and/or its individual layers) and the blister bottom film 5 are identical. In this respect, it is conceivable that all bonds are ester bonds, but that the respective polyesters differ and are, for example, a polylactide (PLA) on the one hand and a polyethylene terephthalate (PET) on the other.

FIG. 2 shows a further embodiment of a blister package 10 according to the invention with blister sealing film 1. In contrast to the embodiment shown in FIG. 1, the blister sealing film 1 is made up of more than two layers. In the example shown, the blister sealing film 1 is made up of three layers. In the example shown, a further plastic layer 4 is arranged between the nonwoven 2 and the cover layer 3. This plastic layer can be used, for example, to improve the bond between the nonwoven 2 and the cover layer 3. Preferably, this layer 4 also has a plastic that can be recycled together with the plastic of the non-woven layer 2 and the cover layer 3.

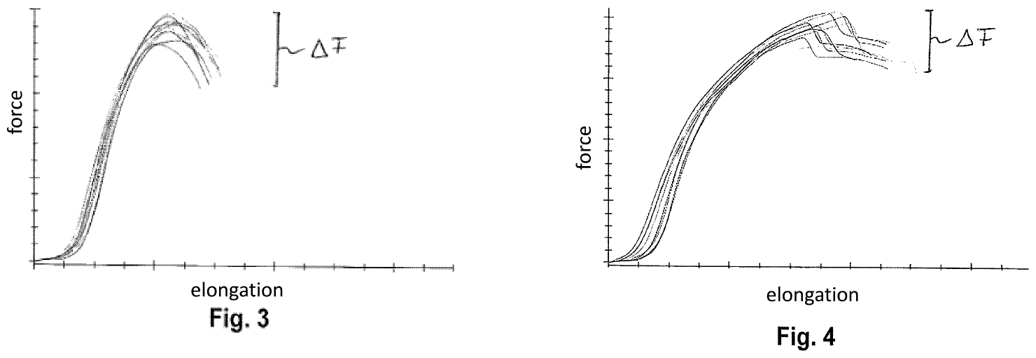

FIGS. 3 and 4 each show schematic representations of the results of measurements of the puncture resistance of a blister sealing film known from the prior art, measured in accordance with DIN EN ISO 14477 with a mandrel with a diameter of 10.5 mm. In FIG. 3, a plastic film has been tested as blister sealing film 1, in FIG. 4 a plastic film containing mineral fillers. In both cases, it can be that the test specimen does not tear in the area of maximum force application (i.e. the measurement curve ends in this area due to the tear and the resulting sudden drop in force (to zero) for further advancement of the test mandrel). Rather, it can be seen that after exceeding the maximum force required for a further advance of the test mandrel and the associated elongation of the test specimen, the force for a further advance of the test mandrel decreases until the test specimen tears. This can be explained by the fact that the plastic of the test specimen is stretched in the area of maximum force application in such a way that the thickness of the test specimen decreases and thus the force required for further stretching of the test specimen also decreases.

For the test specimen with mineral additives (FIG. 4), in contrast to the measurement shown in FIG. 3, it can be seen that after exceeding the feed rate at which the maximum force was required, the force required for the further feed of the test mandrel does not decrease continuously, but instead falls comparatively slowly after a rapid drop.

Both a curve as shown in FIG. 3 and the curve shown in FIG. 4 are extremely unfavorable for a film that is to be used as a blister sealing film. This can be explained by the fact that a user does not control the opening of a blister package in a feed-controlled manner (like the measuring apparatus), but in a force-controlled manner. A user will therefore continuously increase the force applied to the blister pack until the pack opens. If a user now applies a force that is higher than the maximum force shown in the diagrams in FIGS. 3 and 4, further feeding will take place very quickly, as the force required for feeding decreases. This causes the blister sealing film to tear open abruptly under a force that is greater than the force that would actually be required to tear open the blister sealing film (ΔF). This additional or excess force can, for example, be converted into an acceleration of the packaged contents. In blister packs containing tablets with such blister sealing films, for example, it often happens that a tablet is accelerated after being squeezed out in such a way that it jumps out of the blister bottom film holder and falls to the floor. It is then unusable and must be disposed of. Blister sealing films that have a force/elongation diagram as shown in FIG. 3 or 4 are therefore unsuitable for blister packaging valuable goods.

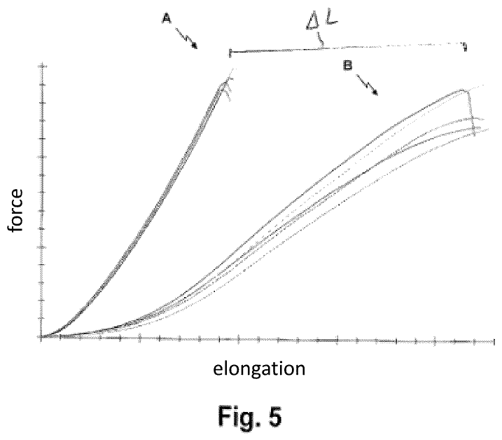

FIG. 5 shows a comparative representation of the results of a measurement of the puncture resistance of a known metal-containing blister sealing film (A) and a blister sealing film according to the invention (B) measured in accordance with DIN EN ISO 14477 with a mandrel with a diameter of 10.5 mm.

As can be seen from these diagrams, both blister sealing films A and B do not exhibit the disadvantageous behavior described in connection with FIGS. 3 and 4. For both blister sealing films, the curve ends immediately after reaching or exceeding the elongation at which the maximum force was required for further advancement of the test mandrel. This makes it easy for a user to continuously increase the force required until the force is reached at which the blister packaging opens or the blister sealing film tears.

FIG. 5 also shows that the force required to open the blister package or to tear the blister sealing film is approximately the same. Accordingly, a user can open a blister pack sealed with a blister sealing film as described above with a similar amount of force as known metal-containing blister sealing films.

It can also be seen from FIG. 5 that the elongation required until the blister sealing film tears is greater. This can be explained by the fact that metal-containing blister sealing films, such as aluminium foils, can only be stretched to a very small extent and are comparatively brittle. This property means that particular care must be taken when processing such blister sealing films in order to avoid damaging the film. A blister sealing film according to the invention can preferably tolerate deformations much better.

As can be seen from the diagram in FIG. 5, the blister sealing film B whose measurement is shown can tolerate deformations (difference in maximum elongation, ΔL) without tearing that are more than twice as large (>20 units) as the deformation required to tear the aluminium film A (<10 units). This makes the handling of a blister sealing film as described above much easier and allows packaging at very high transport speeds.

A higher elongation during processing on a blister machine may be advantageous, as the printed blister sealing film often has to be stretched when it is joined to a blister bottom film so that the printed image is adapted to the blister bottom film.

During sealing, the plastic is slightly weakened by the sealing tool, resulting in lower elongation than the original plastic (measured under laboratory conditions). The invention counteracts this.

Preferably, the blister sealing film can tolerate deformations without tearing that are at least twice as large as the deformations that an aluminium foil, for example, can withstand.

It is further pointed out that the individual figures also describe features which may be advantageous in themselves. The skilled person recognises immediately that a certain feature described in a figure can be advantageous even without adopting further features from this figure. Furthermore, the skilled person recognises that advantages may also result from a combination of several features shown in individual or different FIG.

### LIST OF REFERENCE SIGNS

1 blister sealing film
2 nonwoven, nonwoven layer, second plastic
3 cover layer, plastic layer, first plastic
4 intermediate layer
5 blister bottom film
10 blister package,
A force-strain curve of a metal-containing blister sealing film,
B force-elongation curve of an exemplary blister sealing film according to the invention
ΔF force difference
ΔL difference in maximum

1-12. (canceled)

13. A blister sealing film comprising a first plastic,
wherein
the first plastic is connected to a nonwoven, the fibres of which contain a second plastic which is predominantly based on the same polymers/copolymers as the first plastic.

14. The blister sealing film according to claim 13,
wherein
the first plastic and the second plastic are based at least to 70 per cent by weight, preferably ≥80 per cent by weight, more preferably ≥90 per cent by weight, in particular preferably ≥95 per cent by weight on the same polymers/copolymers.

15. The blister sealing film according to claim 13,
wherein
the first plastic and the second plastic are selected from a group comprising polyethylene (PE), polypropylene (PP), polystrene (PS), polyester, preferably including polylactide (PLA), polyethylene terephthalate (PET) or polycarbonate (PC), ethylene-vinyl alcohol copolymer (EVOH) and mixtures thereof.

16. The blister sealing film according to claim 13,
wherein
the thickness of the first plastic and/or of the nonwoven is selected such that a puncture resistance of the blister sealing film measured in accordance with DIN EN ISO 14477 with a mandrel having a diameter of 10.5 mm≤deviates by 30%, preferably≤20%, from a puncture resistance of a 20 um thick aluminium foil and/or is in a range of 15-50 N, preferably 20-35 N, in particular preferably in the range of 25-30 N.

17. The blister sealing film according to claim 13,
wherein
a force acting on the blister sealing film, preferably during a test of the puncture resistance of the blister sealing film based on DIN EN ISO 14477 with a mandrel having a diameter of 10.5 mm, increases steadily until the force required for a puncture is reached.

18. The lister sealing film according to claim 13,
wherein
it has a sealable layer which, preferably at a sealing temperature in the range from 100-170° C., preferably 110-160° C., more preferably 120-150° C., in particular preferably 130-140° C., compared to first plastic comprising a test specimen has a seal strength of >6 N/15 mm, preferably >9 N/15 mm, in particular preferably >12 N/15 mm.

19. The blister sealing film according to claim 13,
wherein
the nonwoven is laminated on at least one side, preferably on exactly one side, alternatively on both sides, with a layer of the first plastic or is bonded by the hot bonding method.

20. The blister sealing film according to claim 13,
wherein
the nonwoven comprises stretched fibres and/or the first plastic is uni-or bidirectionally stretched.

21. The blister package comprising a blister bottom film and a blister sealing film according to claim 13.

22. The blister package according to claim 21,
wherein
the blisterbottom film and the blister sealing film each consist of at least 80 per cent by weight, preferably ≥90 per cent by weight, more preferably ≥95 per cent by weight, in particular preferably ≥98 per cent by weight, of a plastic, these plastics being based at least to 70 per cent by weight, preferably ≥80 per cent by weight, more preferably ≥90 per cent by weight, in particular preferably ≥95 per cent by weight, on the same polymers/copolymers.

23. A method for producing a blister sealing film, in particular a blister sealing film according to claim 13, characterised by the steps:
providing a nonwoven comprising a second plastic,
providing a first plastic which is predominantly based on the same polymers/copolymers as the second plastic,
bonding the nonwoven to this first plastic.

24. The method according to claim 23,
wherein
the nonwoven is laminated at least on one side, preferably exactly on one side, alternatively on both sides, with a layer of the first plastic or is bonded using the hot bonding method.
